(19) United States
(12) Patent Application Publication
(10) Pub. No.: US 2025/0158222 A1
(43) Pub. Date: May 15, 2025

(54) CROSSLINKED POLYOLEFIN SEPARATORS FOR BATTERIES THAT CYCLE LITHIUM IONS AND METHODS OF MANUFACTURING THE SAME

(71) Applicant: GM GLOBAL TECHNOLOGY OPERATIONS LLC, Detroit, MI (US)

(72) Inventors: Nathaniel HARDIN, Farmington Hills, MI (US); Fang Dai, Troy, MI (US); Xingcheng Xiao, Troy, MI (US); YIfan Zhao, Troy, MI (US)

(21) Appl. No.: 18/508,844

(22) Filed: Nov. 14, 2023

(51) Int. Cl. H01M 50/417; C08J 3/28; C08J 5/18; H01M 10/0525; H01M 10/0585; H01M 50/403; H01M 50/434; H01M 50/446; H01M 50/449; H01M 50/489

(52) U.S. Cl. CPC H01M 50/417; C08J 3/28; C08J 5/18; H01M 10/0525; H01M 10/0585; H01M 50/403; H01M 50/434; H01M 50/446; H01M 50/449; H01M 50/489; C08J 2323/06; C08J 2323/12; H01M 2220/20

(57) ABSTRACT

A battery that cycles lithium ions includes a negative electrode, a positive electrode, and a separator sandwiched between opposed major facing surfaces of the negative and positive electrodes. The separator has an open microporous structure and includes a polyolefin having a crosslinked structure. When the separator is heated at a temperature of greater than or equal to about 145 degrees Celsius for about 1 hour, the separator has thermal shrinkage in directions parallel to the opposed major facing surfaces of the negative and positive electrodes of less than or equal to about 5%. The separator may be manufactured from a precursor film having an open microporous structure and comprising linear or branched chain polyolefin molecules. The precursor film may be exposed to a source of free radicals such that covalent bonds form between the polyolefin molecules and form a crosslinked polyolefin having a relatively high molecular weight.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to separators for batteries that cycle lithium ions, and more particularly to separators having improved resistance to thermal shrinkage and improved wettability.

Batteries that cycle lithium ions generally include a negative electrode and a positive electrode spaced apart from one another by a separator, and an ionically conductive electrolyte infiltrating the separator that provides a medium for the conduction of lithium ions between the negative and positive electrodes during discharge and charge of the batteries. The separator is configured to physically separate and electrically isolate the negative and positive electrodes from each other while permitting lithium ions to pass therethrough. Commercial separators are oftentimes made of microporous polyolefin materials, for example, polypropylene (PP) and/or polyethylene (PE), which exhibit a combination of good mechanical strength and chemical stability. However, such polyolefin materials may shrink if exposed to elevated temperatures (e.g., temperatures greater than or equal to about 130° C.) and, due to their nonpolar nature, may exhibit poor wettability and absorption of electrolytes comprising polar organic solvents.

### SUMMARY

A battery that cycles lithium ions, in accordance with one or more embodiments of the present disclosure, comprises a negative electrode, a positive electrode, and a separator. The negative electrode and the positive electrode are spaced apart from each other and have opposed major facing surfaces. The separator has an open microporous structure and is sandwiched between the opposed major facing surfaces of the negative electrode and the positive electrode. The separator comprises a polyolefin having a crosslinked structure and, when the separator is heated at a temperature of greater than or equal to about 145 degrees Celsius for about 1 hour, the separator has thermal shrinkage in directions parallel to the opposed major facing surfaces of the negative electrode and the positive electrode of less than or equal to about 5%.

In embodiments, when the separator is heated at a temperature of greater than or equal to about 200 degrees Celsius for about 1 hour, the separator may have thermal shrinkage in a direction parallel to the opposed major facing surfaces of the negative electrode and the positive electrode of less than or equal to about 10%.

The polyolefin may comprise polyethylene, polypropylene, or a combination thereof.

The polyolefin may have a crosslinking degree of greater than or equal to about 10% and less than or equal to about 80%.

In aspects, the polyolefin may have a crosslinking degree of greater than or equal to about 60% and less than or equal to about 70%.

The separator may further comprise a ceramic material.

The separator may have a thickness of greater than or equal to about 5 micrometers and less than or equal to about 500 micrometers.

The battery may further comprise a non-aqueous polar aprotic organic solvent infiltrating the open microporous structure of the separator.

A method of manufacturing a battery that cycles lithium ions, in accordance with one or more embodiments of the present disclosure, comprises exposing a precursor film to a source of free radicals. The precursor film has an open microporous structure and comprises linear or branched chain polyolefin molecules. The precursor film is exposed to the source of free radicals such that covalent bonds form between the polyolefin molecules and form a separator comprising a crosslinked polyolefin having a relatively high molecular weight, as compared to that of the linear or branched chain polyolefin molecules in the precursor film. The separator is sandwiched between opposed major facing surfaces of a negative electrode and a positive electrode and infiltrated with an electrolyte.

The precursor film may comprise polyethylene, polypropylene, or a combination thereof.

Exposing the precursor film to the source of free radicals may comprise irradiating the precursor film with an electron beam, plasma, ionizing radiation, non-ionizing radiation, or a combination thereof.

Exposing the precursor film to the source of free radicals may comprise irradiating the precursor film with an electron beam or gamma radiation. In such case, the precursor film may be exposed to the source of free radicals in the presence of water.

Exposing the precursor film to the source of free radicals may comprise applying a chemical crosslinking agent to the precursor film. The chemical crosslinking agent may comprise a peroxide, benzophenone, or a combination thereof.

Exposing the precursor film to the source of free radicals may further comprise irradiating the precursor film with non-ionizing radiation.

The precursor film may be exposed to the source of free radicals in an inert gas environment or in a subatmospheric pressure environment.

The crosslinked polyolefin may have a crosslinking degree of greater than or equal to about 10% and less than or equal to about 80%.

In aspects, the crosslinked polyolefin may have a crosslinking degree of greater than or equal to about 60% and less than or equal to about 70%. The precursor film may further comprise a ceramic material.

The precursor film may have a thickness of greater than or equal to about 5 micrometers and less than or equal to about 500 micrometers.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a positive electrode, a negative electrode, a porous separator, and an electrolyte infiltrating the positive and negative electrodes and the porous separator.

In the drawings, reference numbers may be reused to identify similar and/or identical elements.

### DETAILED DESCRIPTION

The presently disclosed methods can be used to form separators for batteries that cycle lithium ions having improved resistance to thermal shrinkage and improved electrolyte wettability. The separators may be formed by crosslinking polyolefin-containing films to form highly crosslinked polyolefin structures.

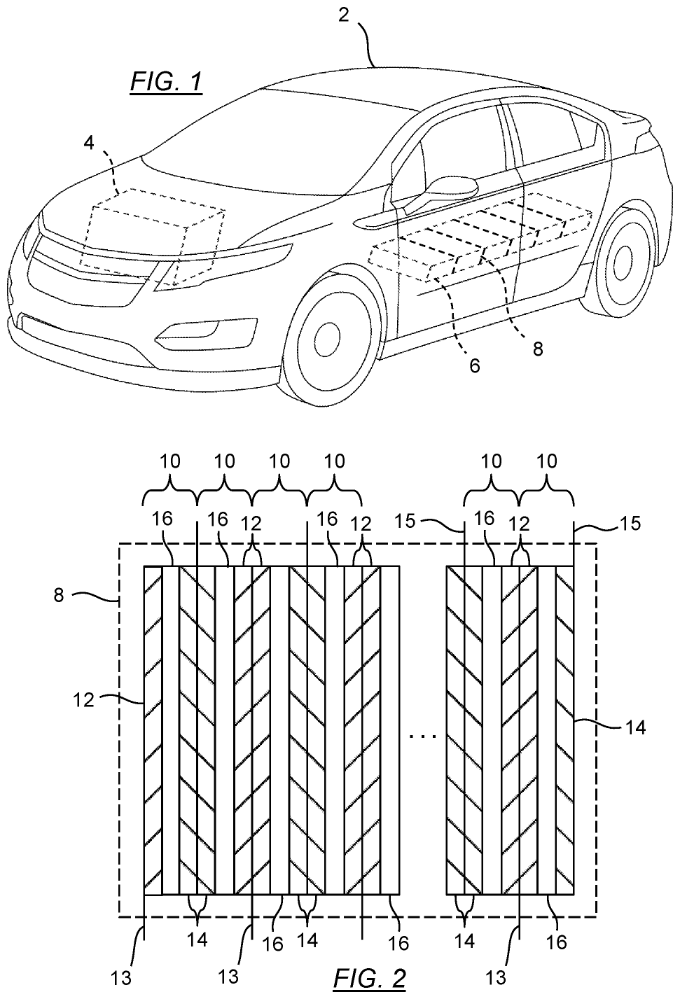

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

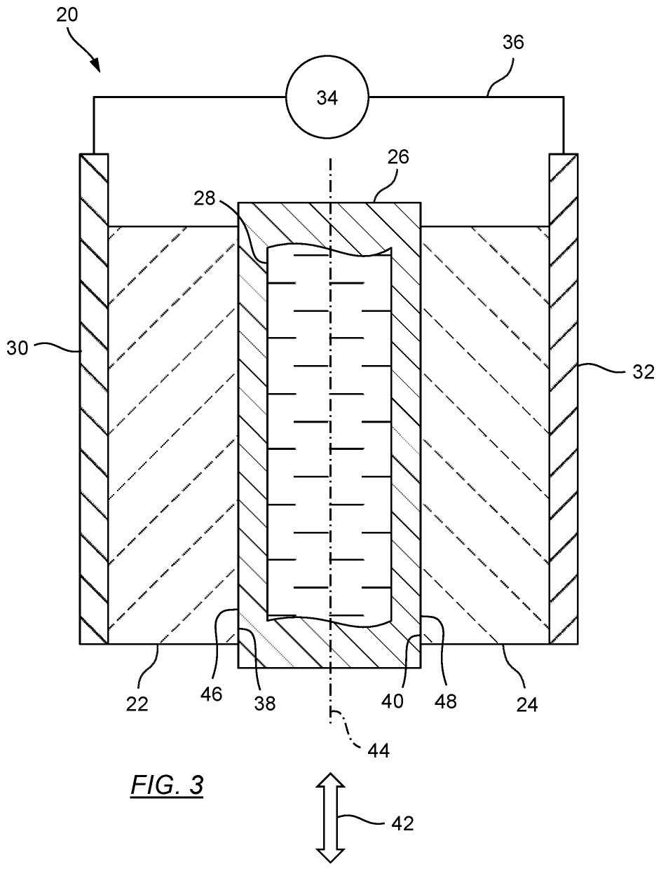

FIG. 3 depicts an electrochemical cell or battery 20 that cycles lithium ions. The battery 20 can generate an electric current during discharge, which may be used to supply power to a load device (e.g., an electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that provides a medium for conduction of lithium ions between the negative electrode 22 and the positive electrode 24. The negative electrode 22 has a major facing surface 38 and the positive electrode 24 has a major facing surface 40 that opposes and faces toward the major facing surface 38 of the negative electrode 22. The negative electrode 22 is disposed on a major surface of a negative electrode current collector 30 and the positive electrode 24 is disposed on a major surface of a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons at the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The separator 26 is configured to physically separate and electrically isolate the negative electrode 22 and the positive electrode 24 from each other while permitting lithium ions to pass therethrough. The separator 26 has an open microporous structure including a plurality of open pores defining a plurality of passages extending therethrough, from a first side 46 to an opposite second side 48 thereof. The separator 26 is sandwiched between the opposed major facing surfaces 38, 40 of the negative electrode 22 and the positive electrode 24. The separator 26 is configured to resist thermal shrinkage in directions 42 parallel to a plane 44 defined between and extending parallel to the major facing surfaces 38, 40 of the negative electrode 22 and the positive electrode 24, which may help prevent a short circuit in the battery 20. The separator 26 may have a thickness extending in a thickness direction perpendicular to the major facing surfaces 38, 40 of the negative electrode 22 and the positive electrode 24 of greater than or equal to about 5 micrometers (μm), optionally greater than or equal to about 10 μm, or optionally greater than or equal to about 20 μm and less than or equal to about 500 μm, optionally less than or equal to about 200 μm, or optionally less than or equal to about 50 μm.

The separator 26 comprises a polyolefin or poly(alkene). The polyolefin may comprise a homopolymer or a copolymer of two or more olefin monomers or a copolymer of one or more olefin monomers and one or more different monomers. Examples of polyolefins include polyethylene (PE), polypropylene (PP), polymethylpentene (PMP), polybutene-1 (PB-1), ethylene-octene copolymers, olefin block copolymers, propylene-butane copolymers, polystyrene (PS), and combinations thereof. In embodiments, the separator 26 may comprise a laminate of polyolefins, e.g., a laminate of PE and PP. Prior to being infiltrated with the electrolyte 28, the polyolefin having the highly crosslinked structure may constitute, by weight, greater than or equal to about 80%, optionally greater than or equal to about 90%, optionally greater than or equal to about 95%, or optionally greater than or equal to about 98% of the separator 26.

The polyolefin in the separator 26 has a highly crosslinked structure, meaning that polymer chains of the polyolefin are chemically linked to one another by a plurality of covalent bonds referred to as bridges. Crosslinking of the polymer chains of the polyolefin increases the molecular weight of the polyolefin. Polymers having a crosslinked structure are different than polymers having a linear structure, in which polymer chains are held together by relatively weak van der Walls forces or hydrogen bonding. Polymers having a crosslinked structure are different than polymers having a branched structure, in which short chains extend from a main polymer chain (or backbone) but do not form bridges.

The highly crosslinked structure of the polyolefin provides the separator 26 with exceptional resistance to thermal shrinkage and with improved wettability, as compared to microporous polyolefin membranes without any crosslinking or with a relatively low degree of crosslinking. The polyolefin in the separator 26 may have a crosslinking degree (also referred to as a crosslink density) of greater than or equal to about 10%, optionally greater than or equal to about 20%, optionally greater than or equal to about 30%, optionally greater than or equal to about 40%, optionally greater than or equal to about 50%, optionally greater than or equal to about 60%, or optionally greater than or equal to about 70% and less than or equal to about 80%.

The relatively high degree of crosslinking in the polyolefin ensures that the polyolefin experiences a relatively small amount of thermal shrinkage when heated at temperatures greater than or equal to about 130 degrees Celsius (° C.). Thermal shrinkage of the separator 26 may be calculated according to the formula (1):

$$Thermal shrinkage ( \% ) = ( {SA}_{0} - SA ) / {SA}_{0} \times 100 \% , \qquad ( 1 )$$

where SA₀ is the surface area of the separator 26 prior to being heated and SA is the surface area of the separator 26 after heating. The surface area (SA₀ and SA) of the separator 26 is the area of a major surface of the separator 26 extending in a direction 42 substantially parallel to the major facing surfaces 38, 40 of the negative electrode 22 and the positive electrode 24, perpendicular to a thickness direction of the separator 26. For example, the surface area (SA₀ and SA) of the separator 26 may be defined by the area of the first side 46 or the second side 48 of the separator 26.

In embodiments, when the separator 26 is heated at a temperature of greater than or equal to about 145 degrees Celsius for about 1 hour, the separator has thermal shrinkage in directions 42 parallel to the opposed major facing surfaces 38, 40 of the negative and positive electrodes 22, 24 of less than or equal to about 10%, or optionally less than or equal to about 5%. In embodiments, when the separator 26 is heated at a temperature of greater than or equal to about 200 degrees Celsius for about 1 hour, the separator may have thermal shrinkage in directions 42 parallel to the opposed major facing surfaces 38, 40 of the negative and positive electrodes 22, 24 of less than or equal to about 20%, or optionally less than or equal to about 10%.

Notably, the degree of crosslinking in the polyolefin may be controlled or adjusted so that the polyolefin retains the ability to perform a thermal shutdown function. During thermal shutdown of the battery 20, the polyolefin in the separator 26 softens, which causes the pores of the separator 26 to close and block the transfer of lithium ions between the negative electrode 22 and the positive electrode 24, effectively preventing operation of the battery 20. In other words, the degree of crosslinking in the polyolefin may be controlled or adjusted so that the polyolefin does not become a thermoset polymer, which would not soften upon heating. In embodiments where the polyolefin comprises polyethylene, thermal shutdown of the battery 20 may be initiated by the polyolefin when the separator 26 is heated at a temperature of greater than or equal to about 130° C. and less than or equal to about 145° C.

In embodiments, the separator 26 may comprise a ceramic material. In embodiments, the ceramic material may be in the form of a coating disposed on the first side 46 and/or the second side 48 of the separator 26. In embodiments, the ceramic material may be distributed throughout the separator 26, between the first side 46 and the second side 48 of the separator 26. In embodiments, the ceramic material may be distributed substantially uniformly throughout the separator 26. Examples of ceramic materials include alumina (Al₂O₃) and/or silica (SiO₂).

The electrolyte 28 is ionically conductive and provides a medium for the conduction of lithium ions through the separator 26, between the negative and positive electrodes 22, 24. In practice, the electrolyte 28 is introduced into the battery 20 such that the electrolyte 28 infiltrates the open micropores of the separator 26. The electrolyte 28 comprises an organic solvent and a lithium salt in the organic solvent. The organic solvent is a non-aqueous polar aprotic organic solvent. Non-limiting examples of non-aqueous polar aprotic organic solvents include cyclic carbonates (e.g., ethylene carbonate (EC), propylene carbonate (PC), butylene carbonate (BC), fluoroethylene carbonate (FEC), and vinylene carbonate (VC)); linear carbonates (e.g., dimethyl carbonate (DMC), diethyl carbonate (DEC), ethyl methyl carbonate (EMC)); aliphatic carboxylic esters (e.g., methyl formate, methyl acetate, methyl propionate); lactones (e.g., γ-butyrolactone, γ-valerolactone, and/or δ-valerolactone); nitriles (e.g., succinonitrile, glutaronitrile, and/or adiponitrile); sulfones (e.g., tetramethylene sulfone, ethyl methyl sulfone, vinyl sulfone, phenyl sulfone, 4-fluorophenyl sulfone, benzyl sulfone, and/or sulfolane); aliphatic ethers (e.g., triethylene glycol dimethyl ether, tetraethylene glycol dimethyl ether, 1,3-dimethoxypropane, 1,2-dimethoxyethane, 1-2-diethoxyethane, and/or ethoxymethoxyethane); cyclic ethers (e.g., 1,4-dioxane, tetrahydrofuran, 2-methyltetrahydrofuran), 1,3-dioxolane); phosphates (e.g., triethyl phosphate and/or trimethyl phosphate); and combinations thereof. The lithium salt is soluble in the organic solvent and provides a passage for lithium ions through the electrolyte 28. The lithium salt may comprise an inorganic lithium salt, an organic lithium salt, or a combination thereof. Examples of lithium salts include lithium hexafluorophosphate (LiPF₆), lithium difluorophosphate (LiPO₂F₂), lithium perchlorate (LiClO₄), lithium tetrachloroaluminate (LiAlCl₄), lithium iodide (Lil), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethane) sulfonylimide (LiN(CF₃SO₂)₂), lithium bis(fluorosulfonyl)imide (LiN(FSO₂)₂) (LiSFl), lithium tetraphenylborate (LiB(C₆H₅)₄), lithium bis(oxalato) borate (LiB(C₂O₄)₂) (LiBOB), lithium difluoro (oxalato) borate (LiBF₂(C₂O₄)) (LiDFOB), and combinations thereof.

The negative electrode 22 is formulated to store and release lithium ions to facilitate charge and discharge, respectively, of the battery 20. The negative electrode 22 comprises an electrochemically active (electroactive) material that can store and release lithium ions by undergoing a reversible redox reaction with lithium during charge and discharge of the battery 20. Examples of electroactive negative electrode materials include lithium, lithium-based materials, lithium alloys (e.g., alloys of lithium and silicon, aluminum, indium, tin, or a combination thereof), carbon-based materials (e.g., graphite, activated carbon, carbon black, hard carbon, soft carbon, and/or graphene), silicon, silicon-based materials (e.g., silicon oxide, alloys if silicon and tin, iron, aluminum, cobalt, or a combination thereof and/or composites of silicon and/or silicon oxide and carbon), tin oxide, aluminum, indium, zinc, germanium, silicon oxide, lithium silicon oxide, lithium silicide, titanium oxide, lithium titanate, and combinations thereof. In aspects, the negative electrode 22 may further comprise a polymer binder and optionally an electrically conductive material.

The positive electrode 24 is formulated to store and release lithium ions during discharge and charge of the battery 20. The positive electrode 24 comprises an electroactive material, a polymer binder, and optionally an electrically conductive material. The electroactive material of the positive electrode 24 can store and release lithium ions by undergoing a reversible redox reaction with lithium at a higher electrochemical potential than the electrochemically active material of the negative electrode 22 such that an electrochemical potential difference exists between the negative electrode 22 and the positive electrode 24. The electroactive material of the positive electrode 24 may comprise a material that can undergo lithium intercalation and deintercalation or a material that can undergo a conversion reaction with lithium. In aspects where the electroactive material of the positive electrode 24 comprises an intercalation host material that can undergo the reversible insertion or intercalation of lithium ions, the electroactive material of the positive electrode 24 may comprise a lithium transition metal oxide.

The negative electrode current collector 30 and the positive electrode current collector 32 are electrically conductive and provide an electrical connection between the external circuit 36 and the negative electrode 22 and the positive electrode 24, respectively. In aspects, the negative electrode current collector 30 and the positive electrode current collector 32 may be made of metal and may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

### Methods

The separator 26 may be manufactured by subjecting a precursor film having an open microporous structure and comprising a polyolefin to a crosslinking process. The polyolefin in the precursor film comprises a plurality of linear or branched chain polyolefin molecules. In some embodiment, the precursor film may further comprise a ceramic material, e.g., Al₂O₃ and/or SiO₂, which may be formed as a coating on surface of the precursor film and/or distributed substantially uniformly throughout the precursor film.

The precursor film may be formed by molding a polyolefin-containing precursor into the shape of a film, for example, by extrusion, casting, blow molding, or a combination thereof, and then optionally subjecting the as-formed film to a uniaxial or biaxial stretching process. Precursor films are available from commercial battery separator manufacturers such as Asahi Kasei Corporation, Celgard, ENTEK (e.g., ENTEK 12EPH), LG Chem Ltd., SEMCORP Global, SK Innovations LTD., Sojo Electric Co., Toray, UBE Corporation, and Sumitomo Chemical Co. Ltd.

Crosslinking of the precursor film may be performed by exposing the precursor film to a source of free radicals such that covalent bonds form between the polyolefin molecules in the precursor film and create a highly crosslinked polyolefin having a relatively high molecular weight, as compared to the molecular weight of the linear or branched chain polyolefin molecules present in the precursor film. The precursor film may be exposed to a source of free radicals, for example, by irradiation, application of a chemical crosslinking agent, and/or by heat treatment.

In embodiments, the precursor film may be crosslinked by irradiating the precursor film with an electron beam, plasma, ionizing radiation, non-ionizing radiation, and a combination thereof. Examples of ionizing radiation include x-rays, gamma radiation, high energy ultraviolet light, and combinations thereof. Examples of non-ionizing radiation include radio waves, microwaves, visible light, infrared light, ultraviolet light, and combinations thereof. In some embodiments, the precursor film may be crosslinked by irradiating the precursor film in the presence of water.

A chemical crosslinking agent may assist in the generation of free radicals and/or may function as a source of free radicals during the crosslinking process. The use of a chemical crosslinking agent may be required in embodiments where crosslinking of the precursor film is performed by irradiation with non-ionizing radiation and/or by heat treatment. Examples of chemical crosslinking agents include inorganic peroxides, organic peroxides, azo compounds, amines, amides, silanes, epoxies, isocyanates, and combinations thereof. More specific examples of chemical crosslinking agents include diacyl peroxides, hydroperoxides, peresters, peroxyesters, peroxycarbonates, dialkyl peroxides, perketals, ketone peroxides, peroxyketals, cyclic peroxides, diarylketones (e.g., benzophenone), peroxycarbonates, dicumyl peroxide, benzoyl peroxide, dibenzoyl peroxide, dilauryl peroxide, methyl ether ketone peroxide, and combinations thereof.

In embodiments where a chemical crosslinking agent is used during the crosslinking process, the chemical crosslinking agent may be applied to the precursor film such that the chemical crosslinking agent is substantially uniformly deposited on surfaces of the precursor film, including within the open micropores thereof. In aspects, a chemical crosslinking agent may be applied to the precursor film by preparing a solution comprising the chemical crosslinking agent in a polar solvent, and then infiltrating or impregnated the precursor film with the solution such that the solution fills the open micropores thereof. The polar solvent may comprise an aqueous solvent (e.g., water) or an organic solvent. Examples of organic solvents include acetic acid, formic acid, alcohol (ethanol, methanol, and/or isopropanol), ethyl acetate, tetrahydrofuran (THF), dichloromethane, acetone, acetonitrile (ACN), dimethylformamide (DMF), and combinations thereof. The precursor film may be infiltrated or impregnated with the solution comprising the chemical crosslinking agent, for example, by ultrasonic spray coating, dip coating, or flow coating.

Crosslinking of the precursor film may be performed in an inert gas atmosphere (e.g., argon and/or nitrogen) and/or in a subatmospheric pressure environment (e.g., a vacuum).

In embodiments, crosslinking of the precursor film may be accomplished by infiltrating the precursor film with a solution comprising, by weight, 5% benzophenone in isopropanol, and then irradiating the precursor film with ultraviolet light having wavelengths in a range of from 290 nanometers (nm) to 320 nm (UV-B light) for about 5 minutes.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.” As used herein, the term “and/or” includes combinations of one or more of the associated listed items.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

Any method steps, processes, and operations described herein are not to be construed as necessarily requiring their performance in the order discussed or illustrated, unless specifically identified as an order of performance. It is also to be understood that additional or alternative steps may be employed, unless otherwise indicated. Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer, or section. Terms such as “first,” “second,” and other numerical terms when used herein do not imply a sequence or order unless clearly indicated by the context. Thus, a first step, element, component, region, layer, or section discussed below could be termed a second step, element, component, region, layer, or section without departing from the teachings of the example embodiments.

Throughout this disclosure, the numerical values represent approximate measures or limits to ranges and encompass minor deviations from the given values and embodiments, having about the value mentioned as well as those having exactly the value mentioned. Other than the working examples provided at the end of the detailed description, all numerical values of parameters (e.g., of quantities or conditions) in this specification are to be understood as being modified in all instances by the term “about” whether or not “about” actually appears before the numerical value. Numerical values of parameters in the appended claims are to be understood as being modified by the term “about” only when such term appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%. In addition, disclosure of ranges includes disclosure of all values and further divided ranges within the entire range, including endpoints and sub-ranges given for the ranges.

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. A battery that cycles lithium ions, the battery comprising:
a negative electrode;
a positive electrode spaced apart from the negative electrode, the negative electrode and the positive electrode having opposed major facing surfaces; and
a separator having an open microporous structure and being sandwiched between the opposed major facing surfaces of the negative electrode and the positive electrode, the separator comprising a polyolefin having a crosslinked structure and, when the separator is heated at a temperature of greater than or equal to about 145 degrees Celsius for about 1 hour, the separator has thermal shrinkage in directions parallel to the opposed major facing surfaces of the negative electrode and the positive electrode of less than or equal to about 5%.

2. The battery of claim 1, wherein, when the separator is heated at a temperature of greater than or equal to about 200 degrees Celsius for about 1 hour, the separator has thermal shrinkage in a direction parallel to the opposed major facing surfaces of the negative electrode and the positive electrode of less than or equal to about 10%.

3. The battery of claim 1, wherein the polyolefin comprises polyethylene, polypropylene, or a combination thereof.

4. The battery of claim 1, wherein the polyolefin has a crosslinking degree of greater than or equal to about 10% and less than or equal to about 80%.

5. The battery of claim 1, wherein the polyolefin has a crosslinking degree of greater than or equal to about 60% and less than or equal to about 70%.

6. The battery of claim 1, wherein the separator further comprises a ceramic material.

7. The battery of claim 1, wherein the separator has a thickness of greater than or equal to about 5 micrometers and less than or equal to about 500 micrometers.

8. The battery of claim 1, further comprising:
a non-aqueous polar aprotic organic solvent infiltrating the open microporous structure of the separator.

9. A method of manufacturing a battery that cycles lithium ions, the method comprising:
exposing a precursor film having an open microporous structure and comprising linear or branched chain polyolefin molecules to a source of free radicals such that covalent bonds form between the polyolefin molecules and form a separator comprising a crosslinked polyolefin having a relatively high molecular weight, as compared to that of the linear or branched chain polyolefin molecules in the precursor film;
sandwiching the separator between opposed major facing surfaces of a negative electrode and a positive electrode; and
infiltrating the separator with an electrolyte.

10. The method of claim 9, wherein the precursor film comprises polyethylene, polypropylene, or a combination thereof.

11. The method of claim 9, wherein exposing the precursor film to the source of free radicals comprises irradiating the precursor film with an electron beam, plasma, ionizing radiation, non-ionizing radiation, or a combination thereof.

12. The method of claim 9, wherein exposing the precursor film to the source of free radicals comprises irradiating the precursor film with an electron beam or gamma radiation, and wherein the precursor film is exposed to the source of free radicals in the presence of water.

13. The method of claim 9, wherein exposing the precursor film to the source of free radicals comprises applying a chemical crosslinking agent to the precursor film.

14. The method of claim 13, wherein the chemical crosslinking agent comprises a peroxide, benzophenone, or a combination thereof.

15. The method of claim 13, wherein exposing the precursor film to the source of free radicals further comprises irradiating the precursor film with non-ionizing radiation.

16. The method of claim 9, wherein the precursor film is exposed to the source of free radicals in an inert gas environment or in a subatmospheric pressure environment.

17. The method of claim 9, wherein the crosslinked polyolefin has a crosslinking degree of greater than or equal to about 10% and less than or equal to about 80%.

18. The method of claim 9, wherein the crosslinked polyolefin has a crosslinking degree of greater than or equal to about 60% and less than or equal to about 70%.

19. The method of claim 9, wherein the precursor film further comprises a ceramic material.

20. The method of claim 9, wherein the precursor film has a thickness of greater than or equal to about 5 micrometers and less than or equal to about 500 micrometers.
